(19) United States
(12) Patent Application Publication
(10) Pub. No.: US 2002/0005068 A1
(43) Pub. Date: Jan. 17, 2002

(54) Capacitive sensor condensation-type hygrometer

(76) Inventor: Kenneth G. Libbrecht, Pasadena, CA (US)

Correspondence Address: SCOTT C. HARRIS, Fish & Richardson P.C., 4350 La Jolla Village Drive, Suite 500, San Diego, CA, 92122, US

(21) Appl. No.: 09/854,431

(22) Filed: May 11, 2001

Related U.S. Application Data
(60) Provisional application No. 60/203,554, filed on May 11, 2000.

(51) Int. Cl. G01N 1/00; G01N 19/00

(52) U.S. Cl. 73/335.04

(57) ABSTRACT

A hygrometer includes a capacitive sensor with a capacitance that changes in response to water or ice forming on its surface. A controller controls a thermoelectric module to cool the sensor until dew forms on the surface of the sensor. The controller then controls the thermoelectric module to heat or cool in response to a sharp change in the capacitance of the sensor, which occurs at the dew (or frost) point temperature of the ambient air, until the sensor reaches equilibrium at the dew (or frost) point temperature.

### CROSS-REFERENCE TO RELATED APPLICATION

This application claims priority to U.S. Provisional Application Ser. No. 60/203,554, filed on May 11, 2000.

### BACKGROUND

Hygrometers may be used to measure the dew point of air, which indicates the amount of moisture in the air. This information may be used for weather observation and forecasting, and for environmental control in industrial applications.

Chilled mirror hygrometers employ an optic sensor to determine the dew point of the ambient air. A metallic mirror is chilled using a thermoelectric heat pump until dew just begins to form. A beam of light, typically from a solid-state light emitting diode (LED), is aimed at the mirror surface and a photodetector monitors the reflected light. As dew drops form on the mirror surface, the reflected light is scattered, which decreases the output of the photodetector. The output of the detector controls the thermoelectric heat pump, forming a feedback system which may be used to bring the mirror to the temperature at which the water on the mirror surface is in equilibrium with the water vapor pressure in the air above the mirror, i.e., the dew point temperature.

Chilled mirror hygrometers provide precise humidity measurements and may be useful in extreme operating environments. However, because chilled mirror hygrometers depend on the optical characteristics of the mirror, they may be sensitive to contamination.

### SUMMARY

A hygrometer according to an embodiment includes a capacitive sensor. The capacitance of the sensor changes in response to water or ice forming on its surface. A controller controls a heat pump, e.g., a thermoelectric module, to cool the sensor until dew (or frost) forms on a surface of the sensor. The controller then controls the heat pump to heat or cool the sensor in response to a sharp change in the capacitance of the sensor, which occurs at the dew (or frost) point temperature of the ambient air, until the sensor reaches equilibrium at the dew (or frost) point.

The capacitive sensor may include an array of interdigitated electrodes deposited or otherwise formed on a thermally conducting and electrically insulating substrate, for example, a glass or sapphire substrate.

The hygrometer may include a thermistor to measure the temperature of the sensor and a thermistor to measure the temperature of the ambient air. A bridge circuit may be connected between the thermistors and used to determine the difference in temperature between the sensor and the ambient air. The controller may use this information to calculate the relative humidity of the ambient air.

The controller may use a capacitive bridge circuit coupled between the sensor and a reference capacitor to monitor changes in the capacitance of the sensor.

### BRIEF DESCRIPTION OF THE DRAWINGS

FIG. 1 is a perspective view of a capacitive sensor hygrometer according to an embodiment.

FIG. 2 is a plan view of an electrode array according to an embodiment.

FIG. 3 is a schematic diagram of a capacitive sensor hygrometer including a controller according to an embodiment.

FIG. 4 is a flowchart illustrating a dew point measurement operation according to an embodiment.

FIG. 5 is a schematic diagram of a capacitive sensor hygrometer including a controller according to an alternative embodiment.

### DETAILED DESCRIPTION

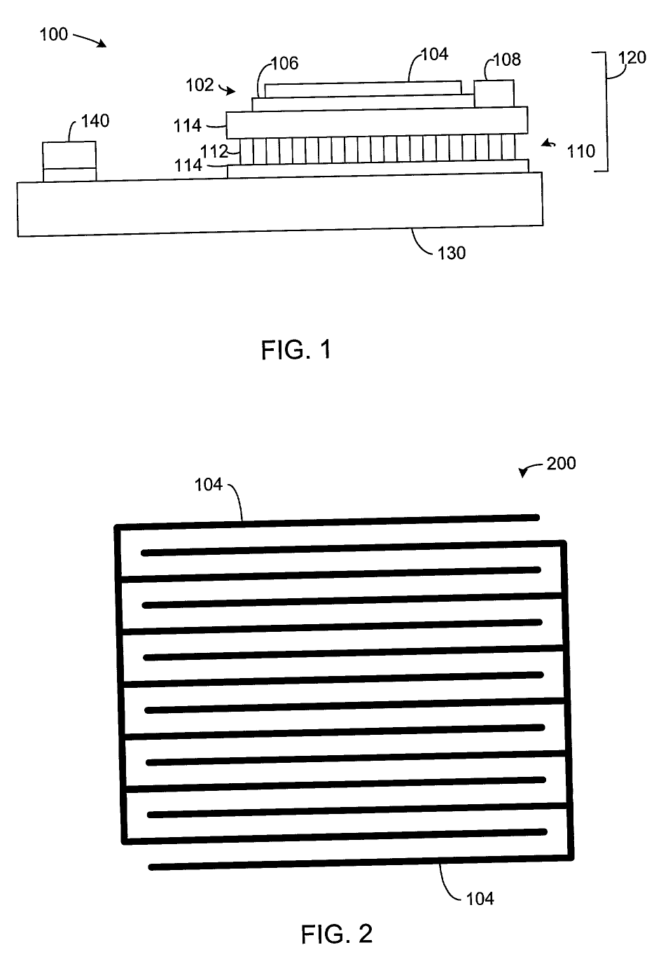

A hygrometer 100 according to an embodiment includes a capacitive sensor 102, as shown in FIG. 1. The capacitive sensor includes an array of interdigitated electrodes 104 formed on a substrate 106. The substrate 106 is made from a material that is electrically insulating and thermally conducting, for example, glass or sapphire. The electrodes 104 may be formed from a metal film, e.g., copper, that is deposited on the substrate 106 and is patterned and etched using semiconductor processing methods. FIG. 2 illustrates an exemplary electrode array 200.

The sensor 102 and a sensor thermistor 108 are attached to a thermoelectric module 110. The sensor and thermistor may be attached to the thermoelectric module 110 with a thermally conductive epoxy such that the electrodes 104 and the thermistor 108 remain at the same temperature. Alternatively, the thermistor may be attached to the top surface of the substrate 106 with the electrodes 104 to ensure that the sensor and thermistor remain at close to the same temperature.

The thermoelectric module 110 operates as a bi-directional heat pump, and may be used to alternately heat and cool the substrate. The thermoelectric module may include one or more pairs of bismuth-telluride pellets 112 sandwiched between two ceramic plates 114. Each pellet pair includes an n-type pellet and a p-type pellet. Although current travels up one pellet and down the other, the carrier current travels in the same direction in both pellets. Thus, heat may transported in one direction in both pellets, creating a “thermally isolated” cold junction at one of the ceramic plates 114. Alternating the direction of the current alternates the direction of heat flow.

A sensor module 120, including the electrodes 104, substrate 106, sensor thermistor 108, and thermoelectric module 110, is attached to a heat sink 130 to absorb heat from and provide thermal energy to the thermoelectric module. A control thermistor 140, thermally isolated from the sensor module 120 and heat sink 130, is used to measure the temperature of the ambient air.

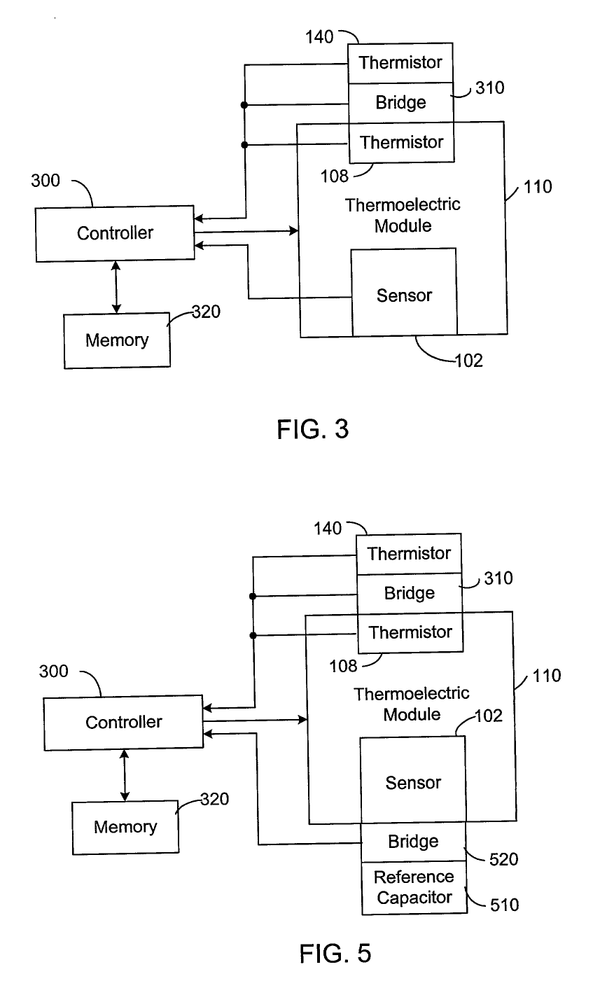

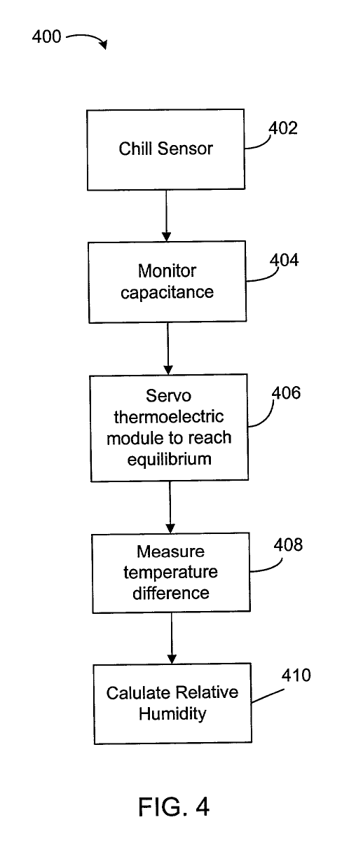

The capacitive sensor hygrometer 100 is connected to a controller 300, as shown FIG. 3, and may be used to perform a humidity measurement operation 400 according to an embodiment, as shown in FIG. 4. The controller 300 monitors the capacitance of the sensor 102 and controls the temperature of the thermoelectric module 110 in response to that measurement. The thermistors 108 and 140 may be connected by a bridge circuit 310. The controller is connected to one or both of the thermistors in order to monitor the ambient and/or sensor temperature. The controller is also connected to the bridge to monitor the temperature difference between the thermistors.

To perform the humidity measurement operation 400, the controller 300 chills the sensor 102. As the sensor 102 cools, dew droplets (or frost particles) begin to form on the surface of the sensor module, between the interdigitated electrodes. An equilibrium state is achieved when the surface of the sensor module is at a temperature at which a layer of condensed water or ice first forms and covers the sensor surface. For temperatures above 0° C., the equilibrium temperature is the dew point temperature. At this temperature, the water layer formed on the sensor surface is in equilibrium with the air directly above the sensor, which is saturated, i.e., holding the maximum amount of water vapor possible at the existing temperature and pressure. For temperatures below 0° C., the equilibrium temperature is referred to as the frost point.

The capacitance of the sensor is very sensitive to the condensed layer on its surface because the dielectric constant of water (about 88 at 0° C.) is very high compared to air (about 1 at 0° C.). The equilibrium temperature is the temperature at which the condensed water or ice layer first fully covers the area between the electrodes 104. At this point, the capacitance of the sensor rises sharply.

The controller 300 monitors the capacitance of the sensor (block 404). Upon passing the equilibrium temperature, indicated by the sharp rise in capacitance, the controller may control the thermoelectric module 110 to alternately heat and cool the sensor 102 until the sensor is in the equilibrium state (block 406). To improve the feedback response of the controller 300 and the thermoelectric module 110, the substrate 106 should have a high thermal conductivity to prevent lag in the transfer of heat from the thermoelectric module at the bottom of the substrate to the top surface of the substrate and the electrode array 200.

The controller 300 determines the difference in temperature between the ambient air and the sensor 102 by the information provided by one or both of the thermistors 108, 140 and the bridge circuit 310 (block 408). The thermistors 108 and 140 provided the absolute temperature of the sensor and the ambient air, respectively, and the bridge circuit 310 provides in the differences between the resistances of the thermistors 108 and 140. The intrinsic thermistor differences may be corrected using a measurement made at thermal equilibrium. Using the bridge circuit to determine the temperature difference between the ambient air and the sensor may provide a more accurate measure of the difference in temperature between the two thermistors.

The controller 300 may then calculate the relative humidity (RH) from the temperature information using tables and/or equations stored in a memory 320 (block 410).

The capacitive sensor hygrometer 100 may be provided on a semiconductor chip, the bulk of which serves as heat sink 130, using semiconductor fabrication methods. Such an integrated capacitive sensor hygrometer may be have side dimensions on the order of 100 μm or smaller. Reducing the size of the sensor may reduce the response time and increase the sensitivity of the sensor. However, miniaturization of the sensor 102 may also decrease the magnitude of the signal generated by the electrode array and used by the controller to achieve the equilibrium state. For smaller sensor modules, the sensitivity of the system may be increased by coupling a reference capacitor 510 to the electrode array with an AC capacitive bridge circuit 520, as shown in FIG. 5. The controller 300 can measure small changes in the signal generated by the electrode array by comparing the changing capacitance of the sensor to the known capacitance of the reference capacitor and control the temperature of the thermoelectric module 110 in response to that comparison.

The capacitive sensor hygrometer 100 may be used in demanding conditions over a wide range of ambient pressures and temperatures. Since the hygrometer monitors electric signals rather than optic signals, as in a chilled mirror hygrometer, the sensor 102 can operate with a fairly thick layer of ice on the electrodes 104 because the capacitance of the sensor is less sensitive to surface contamination than the optical characteristics of the mirror in the chilled mirror hygrometer. Also, a thin protective layer, e.g., a polymer film, may be provided over the sensor 102 without significantly affecting the sensitivity and accuracy of the hygrometer 100.

A number of embodiments have been described. Nevertheless, it will be understood that various modifications may be made without departing from the spirit and scope of the invention. For example, steps of the humidity measuring operation may be performed in a different order and still achieve desirable results. Accordingly, other embodiments are within the scope of the following claims.

1. A hygrometer comprising:
a sensor having a surface and a capacitance that varies in response to water accumulating on the surface;
an electrically controlled heating and cooling device operative to heat and cool the sensor; and
a controller operative to control the heating and cooling device to bring the sensor to an equilibrium temperature in response to a change in the capacitance of the sensor caused by a layer of water accumulating on the sensor surface.

2. The hygrometer of claim 1, wherein the equilibrium temperature is one of a dew point temperature and a frost point temperature of an ambient gas.

3. The hygrometer of claim 1, wherein the controller is operative to control the heating and cooling device to alternately heat and cool the sensor in response to the capacitance of the sensor.

4. The hygrometer of claim 1, wherein the heating and cooling device is a thermoelectric module.

5. The hygrometer of claim 1, wherein the sensor comprises an electrode array and a substrate.

6. The hygrometer of claim 5, wherein the electrode array comprises a plurality of interdigitated electrodes.

7. The hygrometer of claim 5, wherein the substrate comprises a thermally conducting and electrically insulating material.

8. The hygrometer of claim 7, wherein the material comprises sapphire.

9. The hygrometer of claim 7, wherein the material comprises a glass.

10. The hygrometer of claim 2, further comprising:
a first temperature measuring device operative to measure the temperature of the ambient gas; and
a second temperature measuring device operative to measure the temperature of the sensor,
wherein the controller is operative to determine a relative humidity of the ambient gas in response the temperature of the ambient gas and the temperature of the sensor.

11. The hygrometer of claim 10, wherein the first temperature measuring device comprises a first thermistor, and wherein the second temperature measuring device comprises a second thermistor.

12. The hygrometer of claim 10, further comprising a bridge circuit coupled between the first and second thermistors and operative to determine a difference in resistance between the first and second thermistors,
wherein the controller is operative to determine the relative humidity from said difference in resistance.

13. The hygrometer of claim 1, further comprising:
a reference capacitor having a capacitance; and
a capacitance bridge circuit coupled between the sensor and the reference capacitor,
wherein the controller is coupled to the capacitive bridge circuit and operative to determine the change in capacitance of the sensor in response to a signal from the capacitive bridge circuit.

14. The hygrometer of claim 10, further comprising an integrated circuit including the sensor, the first and second thermistors, and the heating and cooling device.

15. The hygrometer of claim 14, wherein the integrated circuit further includes the controller.

16. A method comprising:
exposing a sensor to an ambient gas having a moisture content;
cooling the sensor;
accumulating water on the surface of sensor; and
alternately heating and cooling the sensor to one of dew point temperature and frost point temperature in response to a change in the capacitance of the sensor.

17. The method of claim 16, further comprising:
measuring a temperature of the ambient gas; and
measuring a temperature of the sensor.

18. The method of claim 17, further comprising:
determining a temperature difference between the sensor and the ambient gas; and
calculating a relative humidity value from said temperature difference.
